(19) United States
(12) Patent Application Publication
(10) Pub. No.: US 2002/0072928 A1
(43) Pub. Date: Jun. 13, 2002

(54) Method and system for managing component changes to a business critical application in a production environment

(76) Inventor: Srikanth Sundararajan, Sunnyvale, CA (US)

Correspondence Address: MINTZ, LEVIN, COHN, FERRIS,, GLOVSKY and POPEO, P.C., One Financial Center, Boston, MA, 02111, US

(21) Appl. No.: 09/994,386

(22) Filed: Nov. 27, 2001

Related U.S. Application Data
(60) Provisional application No. 60/253,152, filed on Nov. 27, 2000.

(51) Int. Cl. G06F 17/60

(52) U.S. Cl. 705/1

(57) ABSTRACT

In a process for ensuring compatibility of components in a production environment, components are defined and relationships between two or more components identified to generate an application component definition. This application component definition forms a blue print of the entire production environment as well as for computers, which host the production environment. From relationships between components, inter-relationships between these identified relationships can also be determined. Permutations of potential operations are used to define dynamic inter-relationships. By validating the integrity of these identified relationships and inter-relationships, which are associated with components represented on the production environment, any changes or modifications to these relationships and inter-relationships can be validated prior to their execution. Therefore, the stability of the production environment can be ensured in the event of a component change or modification.

### FIELD OF THE INVENTION

The invention relates to a method and system for ensuring compatibility between a plurality of components related to an organization's production environment, and more particularly the invention ensures the integrity of predefined relationships defined between the components related to the organization's production environment, even if enhancements to one component render it incompatible with another component. The components are modeled in line with the organization's business. This allows the organization to manage changes in the production environment in line with business driven changes.

### BACKGROUND

In the past four to five years there has been an explosive growth in the use of the globally-linked network of computers known as the Internet, and in particular of the WorldWide Web (“WWW”), which is one of the facilities provided by the Internet. In the past couple years, the use of the Java 2 platform, enterprise edition (J2EE) has introduced even more complexity to networked operations. The WWW comprises content consisting of many pages or files of information, distributed across many on-line sources. Some examples of information that can be stored on such pages include: details of a company's organization, contact data, product data and company news. This information can be presented to the end user's desk top computer system (“client computer system”) using a combination of text, graphics, audio data and video data. Content is typically identified by a Universal Resource Locator (“URL”). The URL denotes both the server machine and the particular file or page on that machine. There can be many pages or URLs resident on a single server, however, the URLs are more typically distributed over several locations In order to use and interact with the content on the web (WWW), the client computer system runs a piece of software known as a graphical Web browser, such as Internet Explorer (provided as part of the Windows operating system from Microsoft Corporation), or the Navigator program available from Netscape Communications Corporation. The client computer system interacts with the browser to select a particular URL, which in turn sends a request for that URL or page to the server identified in the URL. Typically the server responds to the request by retrieving the requested page, and transmitting the data for that page back to the requesting client computer system. The client/server interaction is performed in accordance with the hypertext transport protocol (“HTTP”). This page is then displayed to the user on the client screen. The client can also cause the server to launch an application, for example, to search for WWW pages relating to particular topics.

Most Web pages, particularly e-commerce related Web pages, contain one or more references to marketplaces that can provide a variety of goods and/or services. A user can select any combination of goods and/or service and can initiate a transaction related to a particular good and/or service. Generally, after entering a Web page, a user can execute a number of transactions in any number of possible transaction permutations in order to complete an on-line purchase for obtaining goods and/or services. An example of a transaction permutation can include, registering an account, entering credit card information, obtaining information related to goods and/or services as well as selecting the goods and/or services for purchase.

Information system developers are often confronted with the problematic task of implementing and managing software modifications, changes or upgrades to Web pages and associated e-commerce applications, which together enable the transaction. The lack of synchronization between the front end (content of the Web page) and back end (actual software applications of the Web page) can cause unforeseen computer system incompatibilities.

In conventional configuration management, manual installation of modified software applications or components to a stabilized configuration demands specialized user knowledge of the configuration. For example, if a software change, applied to a stabilized configuration corrects a problem affecting system operating parameters, the change would not take effect until the processor has been “rebooted.” In addition, a component modification, intended to correct one problem, may introduce other errors if improperly installed. Without knowledge of the environment and system configuration, an operator cannot ensure the integrity of changes to a previously stable configuration.

Information technology (“IT”) organizations have made numerous attempts to improve and streamline software configuration management. One problem that continues to frustrate IT organizations is that they cannot determine whether a new release will result in a product release incompatible with resident software or hardware until after the new release has been dynamically tested by users in a particular environment. Such a result exposes system developers to allegations of poor testing and development practices and often equates to significant computer downtime.

U.S. Pat. No. 5,499, 357 to Sonty et al (hereinafter Sonty), which is herein incorporated by reference in its entirety, attempts to address issues in configuration management, presented by the more contemporary distributed computer processing systems.

In Sonty, a configuration management method is disclosed, which is useful in eliminating incompatibilities between resident software on the computer system and migration software. However, the configuration management method disclosed in Sonty is not suitable for, nor adaptable to the management of configurations involving dynamic changes, such as in the context of e-commerce applications, where dynamic change transactions can be initiated rapidly. Sonty solves a problem relating to the configuration management of a static system, such as software applications and hardware, having predetermined fixed or static relationships, and is confined to well defined modifications that are driven from long design cycles On the other hand, e-commerce applications, which involve content (web pages), dynamically generated transactions, catalog information, pricing (data), and links to back end systems to reconcile transactions can be subjected to several changes based on any one of a number of permutations that an end user initiates. Therefore, when the application developer and/or the content creator of these applications modifies a component, numerous component incompatibilities can be introduced to the system. The incompatibility problem is further amplified in that developers/creators cannot reliably predict which permutations of e-commerce applications will cause an incompatibility, because numerous permutations are possible at the user's discretion.

The introduction of e-commerce related transactions and the need to connect or link associated e-commerce applications adds a significant level of complexity to managing system configurations across distributed systems. In distributed architectures, system applications and related components are not confined to a single, well behaved, manageable, isolated processing environment. Compatibility of system components and integrity of the environment require continuous verification to ensure integrity across multiple environments running on various processing platforms.

Therefore, an unsolved need remains for an e-commerce application configuration management method, which overcomes the above described limitations and deficiencies of the prior art.

### SUMMARY OF THE INVENTION

The present invention substantially overcomes the deficiencies of the prior art by providing a component change system which accounts for dynamic operations in a networked environment. In particular, the component change system of the present invention is connected to the network of a production environment. The component change system is used to determine compatibility of the hardware and software components of the production environment, even when components are changed. The component change system of the present invention defines inter-relationships between components to ensure stable operation. It accounts for the distributed operation of the production by determining permutations in ordering of processes in defining dynamic inter-relationships.

A change in a component, such as a software application, in the production environment is checked by the component change system for compatibility. The compatibility check is based upon the defined inter-relationships, including the permutations of dynamic inter-relationships. If a component change would result in an incompatibility, the change is not allowed by the component change system. The operator requesting the change is notified of the incompatibility. If compatibility is retained following the component change, then the change is implemented.

### BRIEF DESCRIPTION OF THE DRAWINGS

The foregoing and other objects of this invention, the various features thereof, as well as the invention itself, can be more fully understood from the following description, when read together with the accompanying drawings in which:

FIG. 1 is a high level block diagram of a computer network incorporating a component change manager system according to the present invention; and

FIG. 2 is a representative high-level process flow diagram executable on the component change manager system shown in FIG. 1.

### DETAILED DESCRIPTION

The present invention addresses and eliminates the drawbacks of conventional configuration management methods for automated computing systems by defining components of a production environment, which can be subjected to rapid redesign, modification, removal or replacement. Representative components may include hardware, application modules and language interpreters. Once the relevant components are defined, relationships between two or more components can be identified. An exemplary relationship within an e-commerce application might include, but is not limited to, identified compatibility between a web application server and web server software, which both cooperate to present one or more web pages to an end user, such as a user of a user computer. The web pages can include a plurality of transactions with predetermined content. In this example, the defined components are 1) web application server, and 2) web server software. A functional relationship requires that the web application server and web server software cooperate to generate and provide one or more web pages having predetermined content to the end user of the application.

Identifying relationships can result in relationships between two or more relationships or between a relationship and one or more components. Additionally, each of the components can include sub-components. Thus, identifying relationships can further result in relationships between two or more sub-relationships or between a sub-relationship and one or more sub-components. The relationships between relationships, components, sub-relationships and/or sub-components is hereinafter referred to as “inter-relationships.”

Determining inter-relationships in the process according to the invention defines an application configuration definition that is related to a production environment. An example of the production environment can include an e-commerce web page running a plurality of software components such as web server software programs and web application software programs. Another example of the production environment can include a computer automated assembly line having a plurality of processing stations for assembling a product or good. In this example, each processing station can include a number of components such as hardware and software components that cooperate with each other to perform an assembly task. In both of these examples, the components can have inter-relationships, which for example, can include component attributes, version or release numbers and backwards compatibility information. The inter-relationship information for each component can be collected and stored in a database.

More particularly, in the e-commerce production environment example described above, the inter-relationship information for each of the components included in the e-commerce web page defines an application configuration definition for the e-commerce production environment. Similarly, in the assembly line production environment example described above, the inter-relationship information for each of the components included in the plurality of processing stations defines an application configuration definition for the assembly line production environment.

The application configuration definition for the e-commerce, assembly line or any other production environment can generally provide a blue print for component interrelationships defined on the production environment. This application configuration definition is used as a basis for dynamically managing and ensuring the integrity of changes introduced to components defined in the production environment. Changes introduced to components existing in the production environment can include new software installations, software upgrades, hardware installations and hardware upgrades.

Managing the application configuration definition includes validating the integrity of a relationship or inter-relationship defined in the application configuration definition. Based on a validating result, managing the application configuration definition farther includes maintaining the integrity of a predefined configuration defined in the application configuration definition, which includes relationships and inter-relationships of components, and thus ensuring compatibility of all the identified or predefined components in the application configuration definition.

Configuration maintenance may include, but is not limited to, notifying appropriate system operators of a relationship or inter-relationship inconsistency or taking corrective action to re-establish integrity of the configuration. A representative corrective action may include restoring a specified version of a component to a previous condition or status upon system detection of an error in a pre-determined relationship.

Verifying and maintaining the integrity of the application configuration definition may occur at random intervals or at predetermined intervals. For example, verifying and maintaining defined relationships and inter-relationships, which are associated with components defined in the application configuration definition, may occur when a new system component is installed. Revising existing components and/or adding new components, such as adding enhancements to specific components of a web application server, can expose a stable executing configuration to a potential operating error if the relationship of the components are not verified. Thus, verifying and maintaining the integrity of the application configuration definition is necessary before and after upgrading the e-commerce application with changes to the associated web application server software. Subsequent verification and maintenance checkpoints may be required depending on the significance of the relationship to be validated and impact to the system if a relationship becomes corrupted between checkpoints. Other exemplary opportunities for verification of configuration integrity can include 1) after an initial installation of a complete application, 2) installation of one or more components requiring changes within the context of the application, 3) a partial or complete downgrade of one or more components (e.g., such as a hardware device or software application) to a previous version of a system component, or 4) a partial or complete upgrade of one or more components to a later component version.

The process according to the invention is particularly useful when non-determinative changes occur to one or more components in the system, especially when the defined configuration includes components of different versions, and even more so when the components defined to the configuration are different releases.

Many problems of conventional configuration management systems arise because insufficient information is maintained about a defined configuration during operation. The present invention overcomes this drawback of conventional methods by optionally maintaining status information about the state of the defined application configuration definition during specific periods, such as between pre-determined checkpoints. A method for recording such information can include writing integrity related data, associated with the application configuration definition, to a computer log. Such information may preferably be utilized in subsequent integrity validations to eliminate redundant validation processing.

An embodiment of the inventive method is useful in eliminating incompatible interrelationships between existing components and new components, which are introduced to the production environment. This method comprises defining attributes associated with existing resident components, which defines the existing application configuration definition as previously described. The method further includes defining attributes associated with new components, which will be introduced to the production environment. Additionally, the method includes identifying compatibility relationships between each of the existing resident components; between each of the new components; between the resident components and the new components as well as determining compatibility relationships between the previously described relationships. A dedicated control field is assigned to each compatibility interrelationship or compatibility relationship and is stored. Storing the dedicated control field permits subsequent automated retrieval of the control field for use in periodic integrity validation. Then, prior to performing an upgrade or a change operation, e.g., a hardware reconfiguration, software upgrade or user driven redefinition of content or data; the integrity of the overall production environment is validated by identifying dependency incompatibilities of the relationships.

Finally, incompatibilities identified in the integrity validation are eliminated. Although alternatives exist for identifying incompatibilities, a preferred method reads resident component attribute data (e.g. software version number) and new component attribute data (e.g. software version number), verifies compatibility between resident and new components by comparing current attribute data against the dedicated control field. Upon verification, the method further includes updating current attribute data for the new components, which are redefined as “new” resident components, in the overall production environment. Preferable computer operations are not limited to new component installation, but may include significant upgrade or downgrades of collections of components or entire applications.

Integrity validation in which incompatibilities are identified may occur subsequent to performing a computer operation, and in response to an identified incompatibility, the integrity of the original configuration may be maintained by restoring prior resident components to a previously verified configuration.

In an example of a component change management system according to the present invention, an e-commerce application can include a variety of device and application modules, combined in multiple configurations over a range of version levels with a variety of enabled features. In order to ensure proper combination of the hardware components, application components and other content/data components of the e-commerce application, the configuration management system coordinates proper combination of these components by comparing and verifying component attributes, such as, version and release levels against enabled system feature sets that are pertinent to e-commerce related transactions.

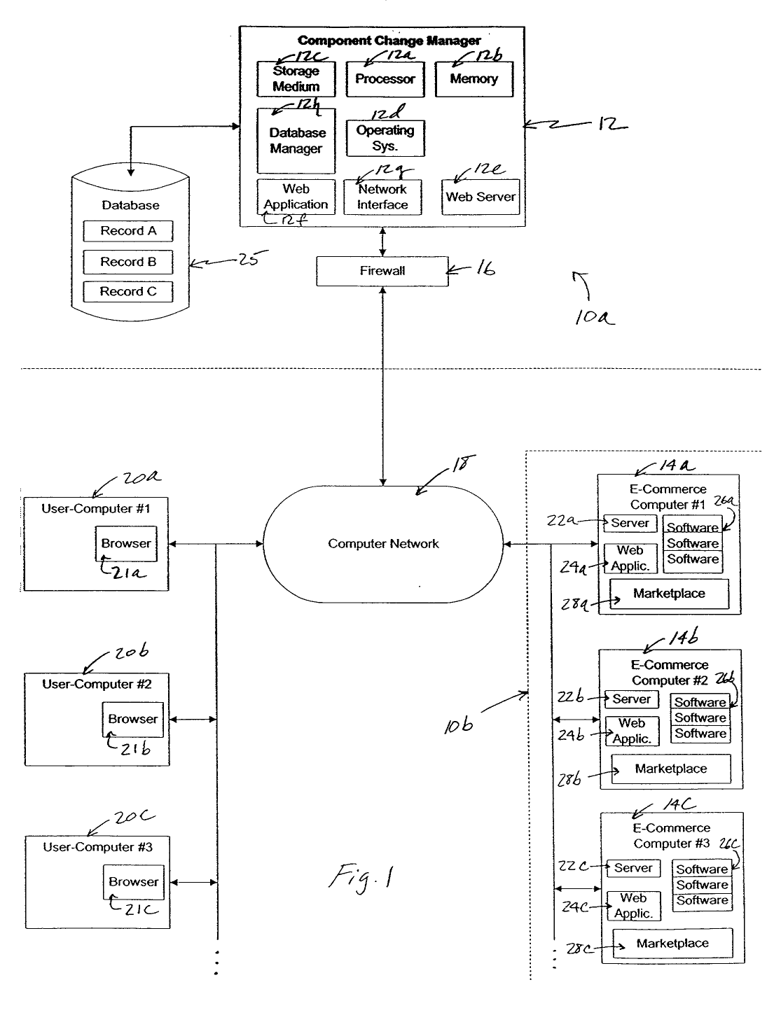

Referring to FIG. 1, FIG. 1 shows a functional block diagram of an embodiment of a computer system 10a for managing component changes to an e-commerce production environment 10b in accordance with the present invention. The e-commerce production environment 10b can include a number of e-commerce servers, 14a, 14b and 14c as shown in FIG. 1.

The system 10a, as shown in FIG. 1, includes a component change manager 12 adapted for communicating information in accordance with a predefined protocol between a plurality of client computers and a plurality of server computers in accordance with the present invention. In this embodiment, the component change manager 12 is coupled to the number of e-commerce servers, 14a, 14b and 14c, via an optional firewall 16 and a communication network 18.

The component change manager 12 is also coupled to a number of end usercomputers, 20a, 20b and 20c, via the optional firewall 16 and the communication network 18. Of course, other configurations are possible such that the component change manager 12 can monitor the hardware and software of at least one of the e-commerce servers.

Each of the e-commerce servers, 14a, 14b and 14c includes appropriate software, such as web server software 22a, 22b and 22b, web application server software 24a, 24b and 24c, a plurality of other software components 26a, 26b and 26c, which are used to run an e-commerce marketplace 28a, 28b and 28c. Each of the e-commerce marketplaces 28a, 28b and 28c includes a number of web pages illustrating numerous goods and/or services.

The communication network 18 can be any one of a number of conventional network systems, utilizing, for example, a combination of well known local area network (LAN) technologies such as Ethernet or Token Ring technologies, or wide area network (WAN) technologies such T1, ISDN, ATM, Frame Relay, FDDI technologies.

The component change manager 12 can include one or more conventional servers such as PC compatible Windows NT based servers available from Compaq Computer Corp., Houston, Texas, running Windows NT server and Internet Information Server available from Microsoft of Richmond, Washington, Sun Solaris based Servers available from Sun Micro Systems of Palo Alto, Calif. and/or LINUX based Servers running LINUX distributed by Red Hat of Durham, N.C. These computer servers can be programmed with conventional languages, which are compatible with evolving standards like J2EE (from Sun MicroSystems).

The web browsers 21a, 21b and 21c respectively defined on user-computers 20a, 20b and 20c can render content using a combination of “Java”, “HTML/DHTML”, “XML”, “JSP”, or “ASP”, with back end connectivity implemented with legacy languages such as “C++”, “J+”, “Perl” or “Perlscript.

The component change manager 12 includes one or more processors 12a, associated memory 12b, a non-volatile storage medium 12c, such as a magnetic or optical disk drive, operating system 12d, web server software 12e, application server software 12f, communication network interface 12g, and database manager 12h. The functionality of the component change manager 12 can be utilized to manage numerous configurations and variants thereof. The functions of the component change manager 12 is provided on a single computer. However, the functions of the component change manager 12 can be distributed over multiple computers in order to promote scalability.

The component change manager 12 further includes a database 25 having a plurality of records A, B and C defined therein. More specifically, the records A, B and C each include a plurality of data fields and associated control fields related to inter-relationships of components located on each of the e-commerce servers 14a, 14b and 14c.

The operating system 12d (e.g., Windows NT Server, LINUX) represented on the component change manager 12 runs the database manager 12h, the application server 12f, and the Web server 12e.

Each user-computer 20a, 20b and 20c include user interface software such as a web browser 21a, 21b and 21c respectively, for providing a user interface to e-commerce servers 14a, 14b and/or 14c. E-commerce servers 14a, 14b and 14c, can send and receive exceptions for system compatibility data and associated records A, B and C from the database 25 at the component change manager 12.

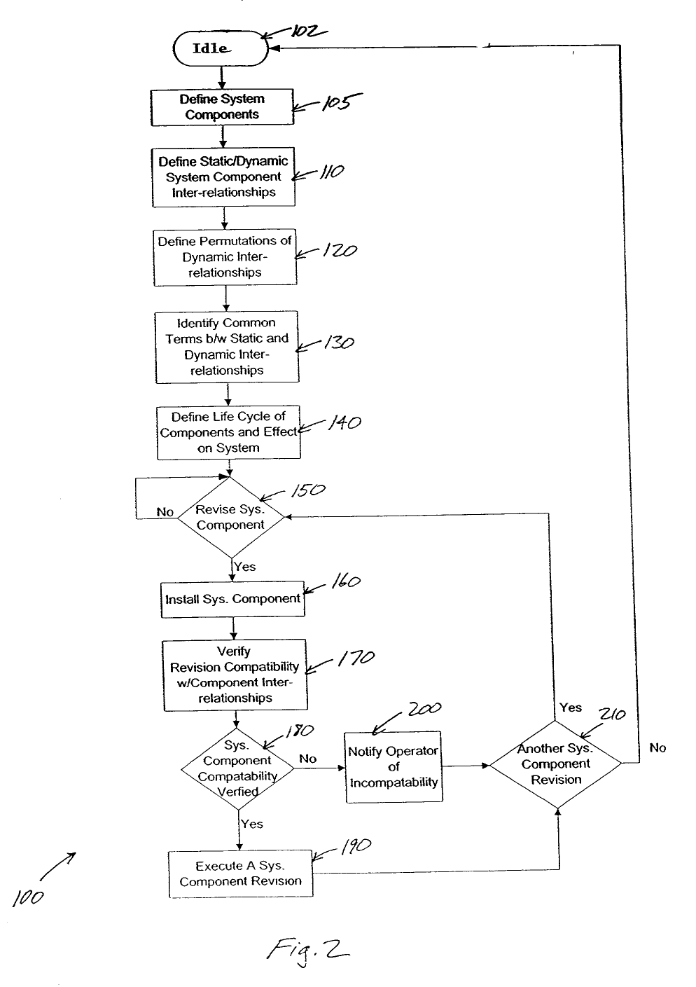

Referring further to FIG. 2, FIG. 2 represents an embodiment of a component change management flowchart 100 illustrating process steps executable on the computer system 10a for managing component changes to a production environment 10b. In this embodiment, the production environment 10b includes a number of e-commerce servers 14a, 14b, and/or 14c, as shown in FIG. 1. At step 102, the system 10a is at an idle state. At step 105, the components and their related attributes for each e-commerce server 14a, 14b and 14c is determined and stored in the database 25. The components and their related attributes for each e-commerce server 14a, 14b and 14c can be obtained manually or from existing databases. Further, the components and their related attributes represented on each e-commerce computer 14a, 14b and 14c can include a combination of hardware and software having predefined version or release numbers, which are operative to present user-computers 20a, 20b and 20c with an e-commerce marketplace 28a, 28b and/or 28c. The e-commerce marketplace 28a, 28b and/or 28c include a number of web-pages (not shown), which have content and/or data for illustrating a plurality goods and/or services. The combination of hardware and software represented on each e-commerce computer 14a, 14b and 14c is hereinafter collectively referred to as “components.”

After defining the components of each e-commerce server 14a, 14b and/or 14c, at step 105, all static and dynamic relationships or inter-relationships between each of the components are defined at step 110. At step 120, a plurality of permutations of dynamic relationships or inter-relationships are also defined. More specifically, the plurality of permutations of dynamic relationships or inter-relationships are determined by determining all possible combinations of components that can be executed to carry out an e-commerce transaction as well as all possible combinations of component relationships and inter-relationships associated with each combination of components.

For example, one permutation of an e-commerce transaction can include a user at user computer 20a, 20b and/or 20c communicating an e-commerce transaction to the e-commerce server 14a, 14b, and/or 14c, which includes 1) selecting a product, 2) selecting a purchase intention, 3) indicating payment terms and 4) indicating shipping information. This permutation example includes four steps as described above. Each step requires at least one component to execute an operation to carry out the step. In this specific instance and in relation to the FIG. 2 flow chart, step 105 includes defining the components as well as their associated attributes for each of the four steps of this example; step 110 includes defining static and dynamic relationships and compatibility relationships between each of the components; and step 120 includes determining all combinations or permutations that the above four steps can be executed to carry out this e-commerce transaction (e.g. indicating shipping information can be selected by a user before indicating payment terms).

The static and dynamic inter-relationships, including the plurality of permutations of dynamic inter-relationships, can be associated with data fields. The data fields are encoded control fields identifying the compatibility of one component (e.g., web server software) with another component (e.g., web application software). The data fields are stored in a record A, B, or C defined on the database 25, which database 25 is represented on the component change manager 12. At step 130, common terms or common inter-relationships are identified between the components. At step 140, a life cycle of the components is also determined, based on customer needs and industry past and present practices. Additionally at step 140, an estimate of the effect that a revision of any one or more of the components would have on the remaining components is also determined. Information related to the common interrelationships, life cycle estimate of the components and an estimated effect a revision would have on any one or more of the components is also stored in data fields. The data fields are stored in the records A, B and/or C defined on the database 25.

The installed and defined components represented on e-commerce computers 14a, 14b and/or 14c, now becomes the current application configuration definition associated with the production environment. The current application configuration definition can include established hardware components, and a particular set of versions of software related to the hardware components. At step 150, an operator of any one of the e-commerce servers 14a, 14b and/or 14c can elect to revise a current application configuration definition associated with the business models or production environments, which are hosted on any one of the e-commerce servers 14a, 14b and/or 14c. At step 160, the operator can execute the revision of the current application configuration definition, which is associated with the business models or production environment, by installing a new component or revising an existing component.

After installing and/or revising the component at step 160, the component change manager 12, at step 170, communicates with the e-commerce server 14a, 14b and/or 14c, which hosts the production environment that received the component revision, to verify that the component revision is compatible with the previously defined system component interrelationships. If the component revision is verified as compatible, at step 180, the component revision is executed at step 190. This component revision becomes the current application configuration definition for the production environment hosted on the e-commerce server 14a, 14b and/or 14c. If, at step 180, the component revision is not verified as compatible, the component revision is not executed at step 190, rather the operator is notified of the incompatible component revision attempt. At step 210, the operator can elect to attempt another component revision or return to the idle state discussed above with respect to step 102.

Although not shown, it can be readily understood by those skilled in the art that other embodiments of the present invention can include substituting the e-commerce production environment 10b with other various business models or productions environments without departing from the spirit and scope of the present invention. For example, the e-commerce production environment 10b can be substituted with an automated manufacturing process, automated assembly line process, or generic computer related business models or production environments, which include features within the spirit and scope of the present invention.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting.

I claim:

1. A method for ensuring compatibility of components in a distributed production environment, comprising the steps of:
defining components of the distributed production environment;
defining static and dynamic inter-relationships between components of the distributed production environment;
defining permutations of dynamic inter-relationships based upon possible operation flows; and
determining compatibility of a component change based upon the defined static and dynamic inter-relationships and the permutations of dynamic inter-relationships.

2. The method for ensuring compatibility of components in a distributed production environment according to claim 1, further comprising the steps of:
preventing a component change for which a compatibility has not been determined;
and
implementing a component change for which a compatibility has been determined.

3. The method for ensuring compatibility of components in a distributed production environment according to claim 2, further comprising the step of notifying an operator when a compatibility is not determined for a component change.

4. The method for ensuring compatibility of components in a distributed production environment according to claim 1, wherein the defining permutations step includes the steps of:
determining a set of possible operations within the production environment;
determining a plurality of orderings of the set of possible operations within the production environment; and
determining dynamic inter-relationships between components based upon each of the plurality of orderings.

5. The method for ensuring compatibility of components in a distributed production environment according to claim 4, wherein the set of possible operations includes processes in an e-commerce transaction.

6. A system for ensuring compatibility of components in a distributed production environment comprising:
a database;
a component change manager connected to the distributed production environment, including:
means for determining components in the distributed production environment;
means for determining static and dynamic inter-relationships between the components in the distributed production environment and storing information regarding the static and dynamic inter-relationships in the database;
means for determining permutations of operations of the components in the distributed production environment; and
means for determining dynamic inter-relationships based upon the permutations of operations and for storing information regarding the dynamic inter-relationships in the database.

7. The system for ensuring compatibility of components in a distributed production environment according to claim 6, wherein the component change manager further includes:
means for receiving an indication of a component change; and
means for determining compatibility of the component change based upon the static and dynamic inter-relationships stored in the database.

8. The system for ensuring compatibility of components in a distributed production environment according to claim 7, further comprising means for preventing a component change when a compatibility is not determined.

9. The system for ensuring compatibility of components in a distributed production environment according to claim 8, wherein the means for preventing includes means for notifying an operator that a compatibility has not been determined.

10. The system for ensuring compatibility of components in a distributed production environment according to claim 7, wherein:
the means for determining permutations includes:
means for defining a set of possible operations within the production environment;
means for determining a plurality of orderings of the set of possible operations within the production environment; and
the means for determining dynamic inter-relationships includes means for dynamic inter-relationships based upon each of the plurality of orderings.

11. The system for ensuring compatibility of components in a distributed production environment according to claim 10, wherein the set of possible operations includes processes in an e-commerce transaction.
